(19) United States
(12) Patent Application Publication
(10) Pub. No.: US 2004/0182512 A1
(43) Pub. Date: Sep. 23, 2004

(54) Pressure sensitive adhesive composition and sheet

(75) Inventor: Masayoshi Matsumoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyo Ink Mfg. Co., Ltd., Tokyo (JP)

(21) Appl. No.: 10/697,118

(22) Filed: Oct. 31, 2003

(30) Foreign Application Priority Data
Mar. 20, 2003 (JP) P2003-077107

(51) Int. Cl. C09J 1/00; C09J 5/00

(52) U.S. Cl. 156/326; 156/311

(57) ABSTRACT

The invention relates to a pressure sensitive adhesive composition containing an acrylic polymer having a weight average molecular weight of 300,000 or higher and produced copolymerizing: a C₁₋₁₄ alkyl (meth)acrylate; 0.2 to 1.8 phr of an ethylenic monomer having a cyclic ether group; and 4 to 8 phr of a polymerizable unsaturated carboxylic acid

### BACKGROUND OF THE INVENTION

1. Field of the Invention

The present invention relates to a pressure sensitive adhesive (hereinafter referred to as “PSA”) composition, a PSA sheet and a production method thereof.

2. Description of the Related Art

Because of its relatively small molecular weight in comparison with emulsion type PSA, a solvent-type PSA is deficient in intermolecular cohesion and incapable of providing desired physical properties (holding power, heat resistance, results of glue extrusion test and the like). In order to obtain a cohesion, polyfunctional isocyanates, epoxy compounds and the like have been used as the crosslinking agents. These crosslinking agents are added immediately before application of a PSA, and such a PSA is called two-component type. However, if the amount is erroneously added in the case of mixing a crosslinking agent, it is difficult to directly inspect such an error. Further, there is a problem of the workability since the usable duration (a pot life) is only a couple of hours after the addition of a crosslinking agent. Moreover, since a worker has to weigh a highly reactive isocyanate or the like every time a PSA is used, one-component type PSA is preferable in terms of safety.

On the other hand, it is supposed that the above-mentioned crosslinking system or a crosslinking system employed for a coating material may be applied to a one-component type PSA. However, since the molecular weight of a polymer to be used for PSA fields is high, if a crosslinking agent is added, there occurs a problem in storage stability (the shelf life) and gelation occurs during long term storage. That is, since the polymer chain is long, even if crosslinking occurs only partially, the molecular weight is considerably increased and following that, the viscosity is also considerably increased.

As a crosslinking agent used for one-component type PSA with good storage stability, those including aluminum or titanium type chelating crosslinking agents, which are complex compounds blocked with alcohol type solvents, have been known, however, there have been problems that the option of the solvents are limited; and the cohesion is insufficient.

As a crosslinking agent, a block isocyanate blocked with methyl ethyl and ketone oxime has been known, however in order to satisfy both requirements for shelf life and reactivity, it is required to carry out application and drying at an extremely high temperature. That is, those with low unblocking temperatures react even at a normal temperature because of the high reactivity and therefore their shelf lives are short. On the other hand, those with high unblocking temperatures have long shelf lives but it is required to increase the temperature for drying to extremely high at the time of application.

Japanese Patent Application Laid-Open No. 10-279901 (hereinafter referred to as Patent Document 1) discloses PSA containing benzotriazole type and hindered amine type UV absorbents and acrylic polymers including glycidyl methacrylate.

Japanese Patent Application Laid-Open No. 3-6282 (hereinafter referred to as Patent Document 2) discloses primer compositions containing benzotriazole compounds and PSA containing acrylic polymers including glycidyl methacrylate.

However, Patent Document 1 does not disclose PSA that contain cyclic ether groups and carboxyl groups as indispensable components. The purpose of the Patent Document 1 is for improving the resistance to light and there is no description relevant to the shelf life of a coating solution, which is very important in order to be usable as a PSA.

Further, with respect to Patent Document 2 the primer compositions with low molecular weights cannot function as PSA. Therefore, the document fails to resolve the problems relevant to the storage stability of PSA that become gels easily owing to high molecular weights.

As described above, any technique for improving the storage stability of a PSA using an acrylic polymer with a relatively high molecular weight for practical application has not yet been proposed.

### SUMMARY OF THE INVENTION

The present invention relates to improve the storage stability of a one-component type solvent PSA though it contains a crosslinking component in order to improve cohesion when it is formed in a PSA sheet.

One aspect of the invention relates to a PSA composition containing an acrylic polymer having a weight average molecular weight of 300,000 or higher and produced by copolymerizing: a (meth)acrylic acid ester having C₁₋₁₄ alkyl; 0.2 to 1.8 phr of an ethylenic monomer having a cyclic ether group; and 4 to 8 phr of a polymerizable unsaturated carboxylic acid.

Another aspect of the invention relates to the above-mentioned PSA composition in which the cyclic ether group is selected from the group consisting of glycidyl group, oxetane group and alicyclic epoxy group.

Another aspect of the invention relates to the above-mentioned PSA composition in which the polymerizable unsaturated carboxylic acid includes acrylic acid.

Another aspect of the invention relates to the above-mentioned PSA composition that further contains a storage stabilizer selected from the group consisting of benzotriazole compounds, amino ether hindered amine compounds, hydroxyphenyltriazine compounds, polyphenol compounds and alkylphenol compounds.

Another aspect of the invention relates to a PSA composition containing the above-mentioned PSA composition and a solvent.

Another aspect of the invention relates to a PSA sheet obtained by applying and drying the above-mentioned PSA composition.

Another aspect of the invention relates to a method for producing the above-mentioned PSA sheet by drying at a drying temperature of 100° C. to 150° C.

Another aspect of the invention relates to a PSA composition containing an acrylic polymer having a weight average molecular weight of 300,000 or higher and produced by copolymerizing: a (meth)acrylic acid ester having C₁₋₁₄ alkyl; 0.2 to 1.8 phr of an ethylenic monomer having a cyclic ether group; 4 to 8 phr of a polymerizable unsaturated carboxylic acid; and a copolymerizable ethylenic unsaturated monomer other than the foregoing monomers.

Further, with respect to a one-component type PSA comprising a cyclic ether group and a carboxyl group, the present invention considerably satisfies both of the mutually contradictory properties of the storage stability of a PSA and the cohesion of an obtained PSA sheet by controlling the amount of the cyclic ether group and the carboxyl group, using as an additive a benzotriazole type compound, a amino ether type hindered amine compound, a hydroxyphenyltriazine compound, a polyphenol type compound, or an alkylphenol type compound and adjusting its addition amount as well as the solid content and molecular weight of the PSA.

The present disclosure relates to subject matter contained in Japanese Patent Application No.2003-77107, filed on Mar. 20, 2003, the disclosure of which is expressly incorporated herein by reference in its entirety.

### DETAILED DESCRIPTION OF THE PREFERRED EMBODIMENTS

The (meth)acrylic acid ester having C₁₋₁₄ alkyl to be used for the present invention may be radically polymerizable acrylic esters of straight chain or branched aliphatic alcohols and methacrylic acid esters of these alcohols. Such examples include methyl (meth)acrylate, ethyl (meth)acrylate, butyl (meth)acrylate, hexyl (meth)acrylate, octyl (meth)acrylate, 2-ethylhexyl (meth)acrylate, decyl (meth)acrylate, dodecyl and (meth)acrylate and the content of the ester is preferably 60 to 95.8 phr. Incidentally, “phr” denotes an abbreviation of part hundred resin and means weight percentage in the acrylic polymer.

The ethylenic monomer having a cyclic ether group to be used for the present invention is preferably an ethylenic monomer including a glycidyl group, an oxetane group, or an alicyclic epoxy group as the cyclic ether group. The examples of such an ethylenic monomer include glycidyl acrylate, glycidyl methacrylate (methacrylic acid glycidyl ester), allyl glycidyl ether, oxetane methacrylate, allyl oxetane, 1,2-epoxy-4-vinylcyclohexane, 3,4-ethoxycyclohexyl methylacrylate, 3,4-epoxycyclohexyl methylmethacrylate, tetrahydrofurfuryl methacrylate and tetrahydrofurfuryl methacrylate. The content of the ethylenic monomer having a cyclic ether group is 0.2 to 1.8 phr, preferably 0.6 to 1.2 phr. If it is lower than 0.2 phr, the cohesion and adhesive force are insufficient when the PSA sheet is formed. If it is higher than 1.8 phr, gelation occurs owing to reaction with a carboxyl group at the time of synthesis in some cases. Further, the storage stability of a PSA solution is deteriorated and it becomes difficult to control the crosslinking system.

The polymerizable unsaturated carboxylic acid to be used in the present invention may include acrylic acid, methacrylic acid, maleic anhydride, maleic acid, itaconic acid and crotonic acid. The content is 4 to 8 phr, preferably 5 to 7 phr. If the content is lower than 4 phr, the cohesion and adhesive force are insufficient when the PSA sheet is formed. If it is higher than 8 phr, gelation occurs by reaction with a cyclic ether group at the time of synthesis in some cases. Further, the storage stability of a PSA solution is deteriorated and it becomes difficult to control the crosslinking system.

A copolymerizable ethylenically unsaturated monomer may be contained in the PSA composition of the present invention. The copolymerizable ethylenically unsaturated monomer may include monomers having functional groups such as hydroxyl, methylol, an amino group, an amido group, an ethyleneimine group, and an isocyanate group, such as, 2-hydroxypropyl (meth)acrylate, 2-hydroxyethyl (meth)acrylate, polyethyleneglycol acrylate and vinyl isocyanate; N-methylacrylolamide, N-methylol-methacrylamide, N-methylaminoethyl acrylate, N-tributylaminoethyl acrylate, N,N-dimethylaminoethyl acrylate, N,N-dimethylaminoethyl methacrylate, N,N-diethylaminoethyl methacrylate, acrylamide, methacrylamide, vinylpyrrolidone, acryloylmorpholine and N-vinylformamide. The content of the copolymerizable ethylenically unsaturated monomer is desirably 0 to 5 phr.

As a copolymerizable ethylenically unsaturated monomer other than the above-mentioned monomers, vinyl ester, vinylpyridine, vinyl acetate, vinyl propionate, styrene, α-methylstyrene, acrylonitrile, methacrylonitrile, isobornyl (meth)acrylate, butadiene and chloroprene can be exemplified. The content of the copolymerizable ethylenically unsaturated monomer other than the above-mentioned monomers, is desirably 0 to 40 phr.

As the solvent for the PSA composition of the present invention, ethyl acetate, butyl acetate, toluene, xylene, methanol, ethanol, isopropyl alcohol, isobutyl alcohol, methyl ethyl ketone, methyl amylketone, methyl isobutylketone, acetone, hexane and cyclohexane can be exemplified.

The weight average molecular weight of the acrylic polymer of the present invention is preferably at least 300,000 and less than 2,000,000, and more preferably at least 500,000 and less than 700,000. If the molecular weight is too low, the cohesion and adhesive force is insufficient when forming a PSA sheet. If the molecular weight is too high, gelation may occur at the time of synthesis in some cases, and the viscosity is increased excessively, so that handling property is deteriorated and the storage stability of the PSA solution is also deteriorated.

The solid content of the PSA composition of the present invention is preferably at least 15% and less than 70%, more preferably at least 25% and less than 40%.

A polymerization initiator to be used for the synthesis reaction is not particularly limited. As an initiator, organic peroxides such as an alkyl peroxide, such as, tert-butyl hydroperoxide, cumene hydroperoxide, p-methane hydroperoxide, isobutyl peroxide, lauroyl peroxide, 3,5,5-trimethylhexanoyl peroxide, octanoyl peroxide, tert-butylcumyl peroxide, benzoyl peroxide, dichlorobenzoyl peroxide, dicumyl peroxide, di-tert-butyl peroxide, 1,1-bis(tert-butylperoxy)-3,3,5-trimethylcyclohexane, 3,3,5-trimethylcyclohexanone peroxide, methylcyclohexanone peroxide, diisobutyl peroxydicarbonate, di-2-ethylhexyl peroxydicarbonate, tert-butyl peroxyisobutyrate; azobisisobutyronitrile, dimethyl azodiisobutylate, 2,2-azobis(2,4-dimethylvaleronitrile), 2,2-azobis(2-methylbutyronitrile), potassium persulfate, sodium persulfate, ammonium persulfate, hydrogen peroxide; 4,4′-azobis-4-cyanovaleric acid ammonium (amine) salt, 2,2′-azobis(2-methylamidoxime) dihydrochloride, 2,2′-azobis(2-methylbutaneamidoxime) dihydrochloride tetrahydrate, 2,2′-azobis{2-methyl-N-[1,1-bis(hydroxymethyl)-2-hydroxyeth yl]-propioneamide}, 2,2′-azobis[2-methyl-N-(2-hydroxyethyl)-propioneamide] can be exemplified.

In order to improve the initial adhesion force or to improve the adhesion force to a specified substrate, a tackifier may be added to the PSA composition of the present invention. For example, rosin resins, phenol resins, polyterpenes, acetylene resins, petroleum type hydrocarbon resins, ethylene-vinyl acetate copolymers, synthetic rubber and natural rubber may be added as tackifiers to the PSA composition. The following can be exemplified: rosin esters such as Super Ester A-75 (produced by Arakawa Chemical Industries, Ltd.), Super Ester A-100 (produced by Arakawa Chemical Industries, Ltd.), and Super Ester A-125 (produced by Arakawa Chemical Industries, Ltd.); polymerized rosin esters such as Pensel D 125 (produced by Arakawa Chemical Industries, Ltd.), Pensel D 160 (produced by Arakawa Chemical Industries, Ltd.), and Rikatack PCJ (produced by Rika Fine Tech. Co.); xylene resins such as Nikanol HP-100 (produced by Mitsubishi Gas Chem. Co., Inc.), Nikanol HP-150 (produced by Mitsubishi Gas Chem. Co., Inc.), and Nikanol HP-80 (produced by Mitsubishi Gas Chem. Co., Inc.); terpene phenol resins such as YS Polyster T-115 (produced by Yasuhara Chemical Co. Ltd.) and Mitec G125 (produced by Yasuhara Chemical Co., Ltd.); petroleum resin such as FTR 6120 (produced by Mitsubishi Gas Chem. Co., Inc.), FTR 6100 (produced by Mitsubishi Gas Chem. Co., Inc.); cumarone-indene resin; terpene resins; styrene resins; and ethylene/vinyl acetate resins.

A storage stabilizer may be added to the PSA composition. As the storage stabilizer, benzotriazole type compounds, amino ether type hindered amine compounds, hydroxyphenyltriazine compounds, polyphenol type compounds, or alkylphenol type compounds are preferable.

Examples of the benzotriazole type compounds are 2-(2′-hydroxy-5′-methylphenyl)benzotriazole, 2-(2′-hydroxy-3′,5′-di-tertbutylphenyl)benzotriazole, 3-(2H-benzotriazol-2-yl)-5-(1,1-dimethylethyl)-4-hydroxyben zenepropanoic acid C₇₋₉ branched or straight chain alkyl ester (trade name TINUVIN 384-2, produced by Ciba Specialty Chemicals K.K.), and 2-(2H-benzotriaxzol-2-yl)-4,6-bis(1-methyl-1-phenylethyl)ph enol.

Examples of the hydroxyphenyltriazine compounds are a mixture of 2-[4-[(2-hydroxy-3-dodecyloxylpropyl)oxy]-2-hydroxyphenyl]-4,6-bis(2,4-dimethylphenyl)-1,3,5-triazine and 2,4-bis(2,4-dimethylphenyl)-6-(2-hydroxy-4-isooctyloxypheny l)-s-triazine.

An example of the amino ether type hindered amine compounds is TINUVIN 123 produced by Ciba Specialty Chemicals K.K.

Examples of polyphenol type compounds are 2,5-di-tert-butylhydroquinone and 2,5-di-tert-butylamylhydroquinone.

Examples of the alkylphenol type compounds are 4,4′-butylidene-bis(6-tert-butyl-3-methylphenol), 1,1-bis(4-hydroxyphenyl)cyclohexane, 2,6-di-tert-butyl-4-methylphenol, 2,2-methylene-bis(4-methyl-6-tert-butylphenlol) and the like.

The above-mentioned storage stabilizers may be added not only solely or may be in form of a mixture in a specified weight part range. Further, use of an amino ether type hindered amine compound in combination with a benzotriazole type compound or a hydroxyphenyltriazine compound can provide synergetic effects in some cases.

The amount of the above-mentioned storage stabilizers is not particularly limited if it is within a range of solubility, however it is 0.001 to 0.02 times as much as the entire PSA composition, preferably 0.0015 to 0.005 times. If it is less than 0.001 times, the addition effect is slight. If it is 0.02 times or higher, the coloration of the PSA becomes significant depending on the types of the storage stabilizers to result in: deterioration of the product value; adverse promotion of crosslinking reaction of the cyclic ether group and the carboxyl group; or promotion of gelation in some cases.

A dye or pigment, a filler or the like may be added to the PSA for providing light shielding properties and concentrated impression to a PSA layer itself or coloring the layer with a specified color.

The polymerization conditions in the present invention are not particularly limited, however, the conditions may be exemplified as follows; a refluxing reaction at a temperature from about 60° C. to 85° C. of a boiling point of an organic solvent in a reaction vessel provided with a stirring apparatus, a thermometer, a dropwise titrating funnel, and a refluxing apparatus. At first, the reaction vessel is loaded with a portion of reaction monomers, a solvent, and a reaction initiator and the mixture is heated to about 60° C. to 85° C. When the refluxing state is achieved, the rest of the monomers, the solvent, and the reaction initiator are dropwise titrated or added dividingly for about 1 to 3 hours while stirring and at the same temperature, aging is carried out at the same temperature for 1 to 4 hours. Finally, the solvent left for cooling may be added. During or after the above-mentioned process, various types of additives such as a tackifier, a storage stabilizer and the like may be added.

A PSA sheet of the present invention can be obtained by transfer coating involving steps of applying a PSA to a release material by a comma coater, a reverse coater, a slot die coater, and the like, drying the PSA, and overlaying and pressing a substrate to the PSA layer. The application amount of the PSA for such a PSA sheet is preferably 2 to 50 g/m², more preferably 5 to 25 g/m², on the basis of dry weight.

A PSA sheet can be obtained also by direct coating involving steps of applying a PSA to a substrate by a comma coater, a reverse coater, a slot die coater, and the like, drying the PSA, and overlaying and pressing a release material to the PSA layer. The application amount of the PSA for such a PSA sheet is preferably 2 to 50 g/m², more preferably 5 to 25 g/m², on the basis of dry weight. In the direct coating, since the anchoring property of the PSA to the substrate is improved, it can be said that a one-component type curable PSA that has quickly reacting properties is suitable for the direct coating.

The application manner of the PSA of the present invention is not limited and for example, a comma coater, a die coater, a slot die coater, a curtain coater, a roll coater, a reverse roll coater, a gravure coater and the like can be exemplified.

The application speed is not particularly limited, however, it is preferably 3 m/minute to 1,000 m/minute, more preferably 10 m/minutes to 60 m/minute.

### EXAMPLES

Hereinafter, the present invention will be described with reference to Examples, however, it is not limited to the exemplified Examples.

Molecular weight was measured by GPC (gel permeation chromatography). GPC is a liquid phase chromatography for separating and quantitatively analyzing the substances dissolved in a solvent on the basis of the molecular size differences of the substances. The molecular weights were determined on the basis of those of polystyrenes.

Viscosity measurement was carried out using a BL type viscometer using #4 rotor under 60 rpm.

In the present invention, holding power was measured by the following procedure. Each PSA sheet was cut into 100×25 mm, a portion with a surface area of 25×25 mm in one end side was stuck to a stainless steel plate under 23° C. and 65% RH conditions and press-bonded to the stainless steel plate by one time going and returning movement of a roll of 2 kg. After the resulting test specimen was left at 40° C. for 20 minutes, a weight of 1 kg was hung down and the time until the weight was dropped was measured of the shift (the creeping state) of the stuck face after a prescribed period was measured.

### Example 1

In a reaction vessel provided with a stirring apparatus, a thermometer, a dropwise titrating funnel, and a refluxing apparatus, raw materials consisting of 180 g of 2-ethylhexyl acrylate, 57 g of butyl acrylate, 40 g of methyl acrylate, 18 g of acrylic acid, 2.75 g of glycidyl methacrylate, 0.45 g of azobisisobutyronitrile, and 274 g of ethyl acetate were divided into halves and loaded in the dropwise titrating funnel and the reaction vessel. After the inside of the vessel was saturated with nitrogen gas and the reaction vessel was heated and refluxed while stirring, titration was started. On completion of the titration, aging was carried out for 3 hours while stirring and then ethyl acetate was added for cooling to obtain a solution containing acryl polymers with 30% by weight of solid content. The obtained PSA composition was stored at 50° C. for 2 weeks. The viscosity was measured and no fluctuation of the viscosity as compared with that before the storage was found.

The viscosity of the PSA composition was found to be 2, 100 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test, and the weight was not dropped even after 70,000 seconds.

### Example 2

A PSA composition was obtained in the same manner as Example 1, except that the amount of acrylic acid was changed to be 22 g. The obtained PSA composition was stored at 50° C. for 2 weeks.

The viscosity was measured and no fluctuation of the viscosity as compared with that before the storage was found.

The viscosity of the PSA composition was found to be 2, 200 mPa.s by viscosity measurement and the weight average molecular weight was found to be 600,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 3

A PSA composition was obtained in the same manner as Example 1, except that the amount of glycidyl methacrylate was changed to be 4.8 g. The obtained PSA composition was stored at 50° C. for 2 weeks. The viscosity was measured and no fluctuation of the viscosity as compared with that before the storage was found.

The viscosity of the PSA composition was found to be 2, 300 mPa.s by viscosity measurement and the weight average molecular weight was found to be 610,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 4

A solution containing acrylic polymers with 35% by weight of solid content was obtained in the same loading and reaction manner as that in Example 1, except that the amount of ethyl acetate was changed. Further, 2-hydroxyphenyltriazine compound (trade name TINUVIN 400, produced by Ciba Specialty Chemicals K.K.) in an amount of 0.002 times was added to the (meth)acrylic acid copolymer solution and stirred at a normal temperature for 30 minutes to obtain the PSA composition of the present invention. The obtained PSA composition was stored at 50° C. for 2 weeks. The viscosity was measured and no fluctuation of the viscosity as compared with that before the storage was found.

The viscosity of the PSA composition was found to be 3,000 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 5

A PSA composition was obtained in the same manner as Example 4, except that 2-hydroxyphenylbenzotriazole compound (trade name TINUVIN 384-2, produced by Ciba Specialty Chemicals K.K.) was used in place of 2-hydroxyphenyltriazine compound. The obtained PSA composition was stored at 50° C. for 2 weeks. The viscosity was measured and no fluctuation of the viscosity as compared with that before the storage was found.

The viscosity of the PSA composition was found to be 3000 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 6

A PSA composition was obtained in the same manner as Example 4, except that an amino ether type hindered amine compound (trade name TINUVIN 123, produced by Ciba Specialty Chemicals K.K.) was used in place of 2-hydroxyphenyltriazine compound. The obtained PSA composition was stored at 50° C. for 2 weeks. The viscosity was measured and no fluctuation of the viscosity as compared with that before the storage was found.

The viscosity of the PSA composition was found to be 3000 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 7

A PSA composition was obtained in the same manner as Example 4, except that a polyphenol type compound (2,5-di-dtert-butylhydroquinone) was used in place of 2-hydroxyphenyltriazine compound. The obtained PSA composition was stored at 50° C. for 2 weeks. The viscosity was measured and no fluctuation of the viscosity as compared with that before the storage was found.

The viscosity of the PSA composition was found to be 3000 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 8

A PSA composition was obtained in the same manner as Example 1, except that oxetane methacrylate was used in place of glycidyl methacrylate. The obtained PSA composition was stored at 50° C. for 2 weeks. The viscosity was measured and no fluctuation of the viscosity as compared with that before the storage was found.

The viscosity of the PSA composition was found to be 2300 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 9

A PSA composition was obtained in the same manner as Example 1, except that 3,4-epoxycyclohexyl methylacrylate was used in place of glycidyl methacrylate. The obtained PSA composition was stored at 50° C. for 2 weeks. The viscosity was measured and no fluctuation of the viscosity as compared with that before the storage was found.

The viscosity of the PSA composition was found to be 2500 mPa.s by viscosity measurement and the weight average molecular weight was found to be 590,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Example 10

A PSA composition was obtained in the same manner as Example 1, except that a raw material composition consisting of 180 g of 2-ethylhexyl acrylate, 97 g of methyl acrylate, 18 g of acrylic acid, 2.75 g of glycidyl methacrylate, 0.45 g of azobisisobutyronitrile, and 274 g of ethyl acetate was used. The obtained PSA composition was stored at 50° C. for 2 weeks. The viscosity was measured and no fluctuation of the viscosity as compared with that before the storage was found.

The viscosity of the PSA composition was found to be 2,200 mPa.s by viscosity measurement and the weight average molecular weight was found to be 610,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Comparative Example 1

A PSA composition was obtained in the same manner as Example 1, except that the amount of glycidyl methacrylate was changed to be 6 g. The obtained PSA composition was stored at 50° C. for 2 weeks. The viscosity was measured and viscosity increase was found.

The viscosity of the PSA was found to be 10,000 mPa.s by viscosity measurement (Before the PSA composition was stored, the viscosity was 2,400 mPa.s) and the weight average molecular weight was found to be 630,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Comparative Example 2

A PSA composition was obtained in the same manner as Example 1, except that the amount of acrylic acid was changed to be 28 g. The obtained PSA composition was stored at 50° C. for 2 weeks. The viscosity was measured and viscosity increase was found.

The viscosity of the PSA was found to be 10,000 mPa.s by viscosity measurement (Before the PSA composition was stored, the viscosity was 2,400 mPa.s) and the weight average molecular weight was found to be 630,000 by GPC.

The PSA composition was applied to a polyester substrate and dried at 110° C. and a release paper was laminated on the PSA face to obtain a PSA sheet. The sheet was subjected to the holding power test and the weight was not dropped even after 70,000 seconds.

### Comparative Example 3

A PSA composition was obtained in the same manner as Example 4, except that a hindered amine compound (trade name TINUVIN 292, produced by Ciba Specialty Chemicals K.K.) was used in place of 2-hydroxyphenyltriazine compound. When the obtained PSA composition was stored at 50° C. for 2 weeks, it became gel.

### Comparative Example 4

A PSA composition was obtained in the same manner as Example 1. The composition was applied to a polyester substrate and dried at 80° C. and a release paper was laminated on the PSA face to obtain a PSA sheet. The sheet was subjected to the holding power test and the weight was dropped after 50,000 seconds.

### Comparative Example 5

An experiment was carried out in the same manner as Example 1, except that 443 g of ethyl acetate and 111 g of toluene were used in place of 274 g of ethyl acetate.

The obtained PSA composition was stored at 50° C. for 2 weeks. The viscosity was measured and the viscosity was unchanged.

The viscosity of the PSA composition was found to be 700 mPa.s by viscosity measurement and the weight average molecular weight was found to be 200,000 by GPC.

The PSA composition was applied to a polyester substrate and dried at 110° C. and a release paper was laminated on the PSA face to obtain a PSA sheet. The sheet was subjected to the holding power test and the weight was dropped even after 200 seconds.

The results of Examples and Comparative Examples are shown in Table 1

TABLE 1

| | viscosity fluctuation | holding | molecular |
|---|---|---|---|
| | with time | power | weight |
| Example 1 | ∘ | ∘ | 590,000 |
| Example 2 | ∘ | ∘ | 600,000 |
| Example 3 | ∘ | ∘ | 610,000 |
| Example 4 | ∘ | ∘ | 590,000 |
| Example 5 | ∘ | ∘ | 590,000 |
| Example 6 | ∘ | ∘ | 590,000 |
| Example 7 | ∘ | ∘ | 590,000 |
| Example 8 | ∘ | ∘ | 590,000 |
| Example 9 | ∘ | ∘ | 590,000 |
| Example 10 | ∘ | ∘ | 610,000 |
| Comparative Example 1 | x | ∘ | 630,000 |
| Comparative Example 2 | x | ∘ | 630,000 |
| Comparative Example 3 | x | ∘ | 590,000 |
| Comparative Example 4 | ∘ | x | 590,000 |
| Comparative Example 5 | ∘ | x | 200,000 |

Evaluation of viscosity fluctuation with time
∘: less than 10% of viscosity increase in the storage test at 50° C. for 2 weeks.
x: 10% or higher of viscosity increase in the storage test at 50° C. for 2 weeks.
Evaluation of holding power
∘: not dropped for 70,000 seconds in the holding power test.
x: dropped within 70,000 seconds in the holding power test.

What is claimed is:

1. A pressure sensitive adhesive composition comprising an acrylic polymer having a weight average molecular weight of 300,000 or higher and produced by copolymerizing: a C₁₋₁₄ alkyl (meth)acrylate; 0.2 to 1.8 phr of an ethylenic monomer having a cyclic ether group; and 4 to 8 phr of a polymerizable unsaturated carboxylic acid.

2. The pressure sensitive adhesive composition according to the claim 1, wherein the cyclic ether group selected from the group consisiting of glycidyl group, oxetane group and an alicyclic epoxy group.

3. The pressure sensitive adhesive composition according to the claim 1, wherein the polymerizable unsaturated carboxylic acid includes acrylic acid.

4. The pressure sensitive adhesive composition according to the claim 1, further containing a storage stabilizer selected from the group consisting of benzotriazole compounds, amino ether hindered amine compounds, hydroxyphenyltriazine compounds, polyphenol compounds and alkylphenol compounds.

5. A pressure sensitive adhesive composition consisting of the adhesive composition according to the claim 1 and a solvent.

6. A pressure sensitive adhesive sheet obtained by applying and drying the pressure sensitive adhesive composition according to the claim 5.

7. A method for producing the pressure sensitive adhesive sheet according to the claim 6 by drying at a drying temperature of 100° C. to 150° C.

8. A pressure sensitive adhesive composition comprising an acrylic polymer having a weight average molecular weight of 300,000 or higher and produced by copolymerizing: a C₁₋₁₄ alkyl (meth)acrylate; 0.2 to 1.8 phr of an ethylenic monomer having a cyclic ether group; 4 to 8 phr of a polymerizable unsaturated carboxylic acid; and a copolymerizable ethylenically unsaturated monomer other than the above-mentioned monomers.
